(19) United States
(12) Patent Application Publication
(10) Pub. No.: US 2016/0088362 A1
(43) Pub. Date: Mar. 24, 2016

(54) CONTENT PLAYBACK DEVICE AND ADVERTISEMENT DISPLAY METHOD FOR CONTENT PLAYBACK DEVICE

(71) Applicant: SHARP KABUSHIKI KAISHA, Osaka (JP)

(72) Inventors: Takashi KANEKO, Osaka-shi (JP); Norio ITOH, Osaka-shi (JP); Masahiro SHIOI, Osaka-shi (JP); Chanbin NI, Osaka-shi (JP); Atsutoshi SHIMENO, Osaka-shi (JP)

(73) Assignee: SHARP KABUSHIKI KAISHA, Osaka-shi, Osaka (JP)

(21) Appl. No.: 14/786,093

(22) PCT Filed: Mar. 18, 2014
(86) PCT No.: PCT/JP2014/057386

§ 371 Date: Oct. 21, 2015

(30) Foreign Application Priority Data
Apr. 22, 2013 (JP) 2013-089820

(51) Int. Cl. H04N 21/81; H04N 21/258; H04N 21/84

(52) U.S. Cl. CPC H04N 21/812; H04N 21/84; H04N 21/25866

(57) ABSTRACT

While executing a television viewing APP, an engine (112) performs another application. A degree-of-concentration determination unit (131) determines the frequency of operations for the application, and calculates the degree of concentration for the program on the basis of the type of the application and the determination result. When the degree of concentration is high, the presentation controller (140) displays an advertisement relevant to the program, on a display unit (150).

### TECHNICAL FIELD

The present invention relates to a content playback device which is capable of, while performing a playback application for playing back video content, performing another application, and also relates to an advertisement display method for the content playback device. In addition, the present invention relates to a program for functioning a computer as the content playback device, and also relates to a recording medium in which the program is recorded.

### BACKGROUND ART

Typically, a distributor who distributes a television program distributes advertisements as well as the main video of the program. Regarding this, various techniques for improving advertising effect have been proposed. Examples of the techniques include those disclosed in PTL 1 to PTL 4.

### CITATION LIST

### Patent Literature

PTL 1: Japanese Patent No. 4658439 (published Aug. 29, 2003)

PTL 2: Japanese Patent No. 4875811 (published May 24, 2002)

PTL 3: International Publication No. 01/028236 (published. Apr. 19, 2001)

PTL 4: Japanese Unexamined Patent Application Publication (Translation of PCT Application) No. 2010-526497 (published Jul. 29, 2010)

### SUMMARY OF INVENTION

### Technical Problem

In recent years, a viewing style in which a television program is viewed while another application other than the television viewing application is being operated by using a smartphone, a tablet terminal, or the like has become popular.

An example of the viewing style is one in which, while a television program is being viewed by using a television viewing application, tweet about the television program is uploaded by using a Twitter application. Another example is one in which, while a television program is being viewed by using a television viewing application, information about the cast of the television program is searched for by using a browser application. These viewing styles enable a user to devote himself/herself to the world of the television program more deeply.

In contrast, a situation may be assumed in which a user who has lost interest in a television program starts using another application irrelevant to the television program while the user still causes a television viewing application to play back the television program.

Thus, even when a television program is being played back, a user is not always interested in the television program, and may be interested in another application irrelevant to the television program. Regarding this, the configuration of the related art fails to perform effective advertisement display in consideration of whether or not the user is interested in the television program.

The present invention has been made in view of the above-describing problem, and the main object thereof is to achieve a content playback device which enables effective advertisement display according to whether or not the user is interested in the video which is being played back.

### Solution to Problem

To solve the above-described issue, a content playback device according to one aspect of the present invention includes playback means for playing back a video of program content, detection means for detecting operations for an application which is being executed, so as to determine the frequency of operations, and advertisement display means for displaying one or more advertisements among a plurality of advertisements including a related advertisement which is an advertisement for which relevance to the program content is specified. The advertisement display means displays the related advertisement in the case where the frequency of operations is equal to or less than a predetermined threshold.

To solve the above-described issue, an advertisement display method for a content playback device, according to one aspect of the present invention includes an advertisement display method for a content playback device, the method including the steps of playing back a video of program content, detecting operations for an application which is being executed, so as to determine the frequency of operations, and displaying one or more advertisements among a plurality of advertisements including a related advertisement which is an advertisement for which relevance to the program content is specified. In the displaying step, the related advertisement is displayed in the case where the frequency of operations is equal to or less than a predetermined threshold.

### Advantageous Effects of Invention

The content playback device according to the aspect of the present invention enables effective advertisement display according to whether or not the user is interested in the video which is being played back.

The advertisement display method for the content playback device, according to the aspect of the present invention enables effective advertisement display according to whether or not the user is interested in the video which is being played back.

### BRIEF DESCRIPTION OF DRAWINGS

FIG. 1 is a block diagram illustrating the configuration of a television receiver according to an embodiment of the present invention.

FIG. 2 is a sequence chart illustrating exemplary operations in a system including the television receiver illustrated in FIG. 1, a content distribution apparatus, an application distribution server, and an advertisement distribution server.

FIG. 3 is a diagram for describing the detail of a degree-of-concentration determination process performed during the operations illustrated in FIG. 2.

FIG. 4 is another diagram for describing the detail of the degree-of-concentration determination process performed during the operations illustrated in FIG. 2.

FIG. 5 is yet another diagram for describing the detail of the degree-of-concentration determination process performed during the operations illustrated in FIG. 2.

FIG. 6 is a flowchart illustrating the detail of the degree-of-concentration determination process and an advertisement display update process which are illustrated in FIG. 2.

FIG. 7 is a diagram which exemplarily illustrates an area in which program content is presented, an area in which an application is presented, and areas in which advertisements may be presented, in a display screen of the television receiver illustrated in FIG. 1.

FIG. 8 is a sequence chart illustrating exemplary operations in a system including a television receiver, a content distribution apparatus, an application distribution server, and an advertisement distribution server according to another embodiment of the present invention.

FIG. 9 includes schematic diagrams illustrating data which is held by the advertisement distribution server illustrated in FIG. 8 and in which keywords which are in an associative relation are associated with each other. FIG. 9(a) illustrates tabular data, and FIG. 9(b) illustrates data having a graph structure.

FIG. 10 is a schematic diagram that illustrates two CM movies which are in an associative relation and which are displayed on the television receiver illustrated in FIG. 8, and that also illustrates a program viewer who is viewing the CM movies.

### DESCRIPTION OF EMBODIMENTS

### First Embodiment

A television receiver which is an embodiment of a content playback device according to the present invention will be described below. The television receiver is merely an embodiment of the present invention. The present invention may be also embodied as a terminal of another type, such as a tablet terminal, a cellular phone (feature phone), a smartphone, a game console, or car navigation equipment.

(Overview)

The television receiver according to the present embodiment accumulates preference information of a user on the basis of a history of operations on the television receiver (for example, a channel selection history or an application operation history including a history of input of search words on a web browser).

In addition, the television receiver according to the present embodiment receives program content transmitted from a distribution apparatus, through a tuner, and plays back the program content. Further, the television receiver according to the present embodiment is capable of downloading various applications (hereinafter, “application” may be abbreviated to “APP”) through a communication interface over the Internet, and executing the downloaded applications. The television receiver is not limited to one having such a configuration, and may receive program content from a distribution apparatus through a communication interface over the Internet. In addition, the television receiver may download applications through the tuner.

In addition, while executing a television viewing APP upon startup so as to start playing back program content of the latest selected channel, the television receiver according to the present embodiment displays advertisement images.

Regarding this, the television receiver according to the present embodiment is characterized in that, when another application (hereinafter also referred to as a “target. APP”) which is being executed in parallel with the television viewing APP is present, the television receiver periodically determines an advertisement image to be displayed, on the basis of the type of the target APP and the frequency of operations of the user for the target APP.

That is, when the user frequently operates the target. APP, it is likely that the user has no interest in the program content. In other words, it is likely that the probability that the user is interested in an advertisement having relevance to the program content is not so high, and that the probability that better advertising effect is obtained when an advertisement conforming to preference information of the user is displayed is high. In consideration of this, when the target APP is frequently operated, the television receiver according to the present embodiment displays an advertisement conforming to the preference of the user, on the basis of the preference information of the user. Not only does the television receiver display an advertisement conforming to the preference of the user on the basis of the preference information of the user, but also the television receiver may be configured so as to display an advertisement related to the target APP (such as a game APP).

The television receiver according to the present embodiment will be further described below with reference to the drawings.

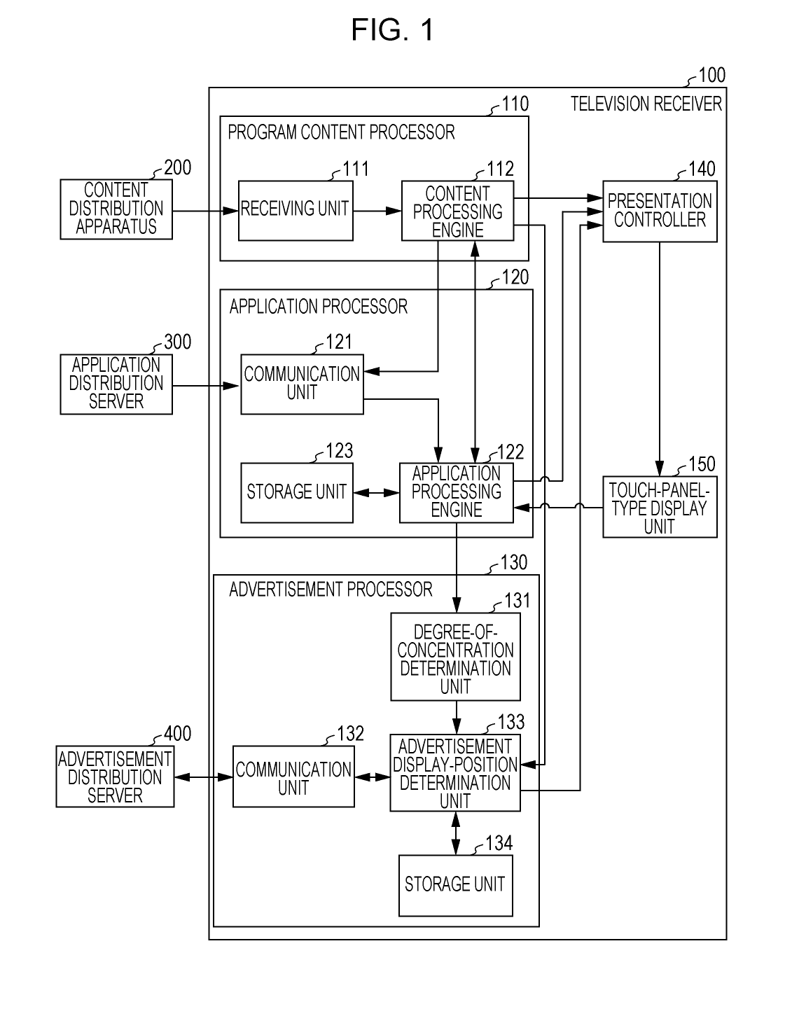

Referring to FIG. 1, the configuration of a principal part of the television receiver according to the present embodiment will be described. FIG. 1 is a block diagram of a television receiver 100 according to the present embodiment.

(Configuration of Television Receiver 100)

As illustrated in FIG. 1, the television receiver 100 includes a program content processor 110, an application processor 120, an advertisement processor 130, a presentation controller 140, and a touch-panel-type display unit 150.

The program content processor 110 includes a receiving unit 111 and a content processing engine 112.

The receiving unit 111 receives content distributed by a content distribution apparatus 200. When the content distribution apparatus 200 is configured as an apparatus distributing content via broadcasting, the receiving unit 111 is implemented as a tuner. When the content distribution apparatus 200 is configured as an apparatus distributing content through communication, the receiving unit 111 is implemented as a communication interface.

The content processing engine 112 processes content information (for example, meta-information such as EPG, program video data, program voice data, subtitles data) included in the received program content. For example, the content processing engine 112 decodes program video data and program voice data included in program content. The content processing engine 112 may be implemented by using a CPU (not illustrated) which is executing a television viewing APP.

The application processor 120 includes a communication unit 121, an application processing engine 122, and a storage unit 123.

The communication unit 121 is a communication interface receiving an APP from an application distribution server 300.

The application processing engine 122 activates an APP which is read from the storage unit 123, and performs various types of processing on the basis of the APP. The application processing engine 122 is implemented by using the CPU.

The storage unit 123 is a storage device in which various APPs distributed from the application distribution server 300 are recorded.

The advertisement processor 130 includes a degree-of-concentration determination unit 131, a communication unit 132, an advertisement display-position determination unit 133, and a storage unit 134.

The degree-of-concentration determination unit 131 determines the degree of concentration of a user for the program content which is being played back.

The communication unit 132 is a communication interface receiving advertisement data from an advertisement distribution server 400.

The advertisement display-position determination unit 133 determines an area in which an advertisement image is to be displayed, on the basis of the magnitude of the degree of concentration which is determined by the degree-of-concentration determination unit 131.

The storage unit 134 is a storage device in which advertisement data distributed from the advertisement distribution server 400 is recorded.

The presentation controller 140 displays a program video which has been decoded by the content processing engine 112, in a program-video display area on the touch-panel-type display unit 150, and displays a UI image of an APP which is generated by the application processing engine 122, in an APP display area on the touch-panel-type display unit 150.

The presentation controller 140 displays an advertisement in an area determined by the advertisement display-position determination unit 133 (an area in the program-video display area or an area in the APP display area).

The touch-panel-type display unit 150 functions as an input device as well as a display device. Specifically, the touch-panel-type display unit 150 functions as an input device receiving an operation for the APP which is being executed.

The configuration of the television receiver 100 according to the present embodiment is described above.

(Content Distribution Apparatus 200)

The content distribution apparatus 200 is a distribution apparatus which is capable of distributing many pieces of program content.

(Application Distribution Server 300)

The application distribution server 300 stores many APPs.

The application distribution server 300 stores information, for each of the many pieces of program content, indicating which APP stored in the application distribution server 300 is an APP related to the piece of program content.

(Advertisement Distribution Server 400)

For each of the many pieces of program content, the advertisement distribution server 400 stores many pieces of advertisement data for a sponsor involved in distribution of the piece of program content.

In the advertisement distribution server 400, for each of the many pieces of program content, information indicating which advertisement data stored in the advertisement distribution server 400 is advertisement data for a sponsor involved in distribution of the piece of program content is recorded.

Further, advertisement data for a sponsor is constituted by actual data (advertisement image data) and metadata. The metadata includes information indicating the degree of association between the advertisement image and program content for which the sponsor is involved in distribution, and also includes information indicating genres of the advertisement (for example, “soccer”, “movie”, “cuisine”). The advertisement image data may be still image data, or may be moving image data.

For example, in the case where program content is about a soccer game and where advertisement data for a certain sponsor is about soccer shoes which are made by A Corp. and which are used by a player in the game, the degree of association which is indicated by the metadata of the advertisement data has a large value. For example, in the case where program content is about the above-described soccer game and where advertisement data for another sponsor is about a snack which is not related to the program, the degree of association which is indicated by the metadata of the advertisement data has the minimum value (for example, 0).

(Exemplary Operations in System)

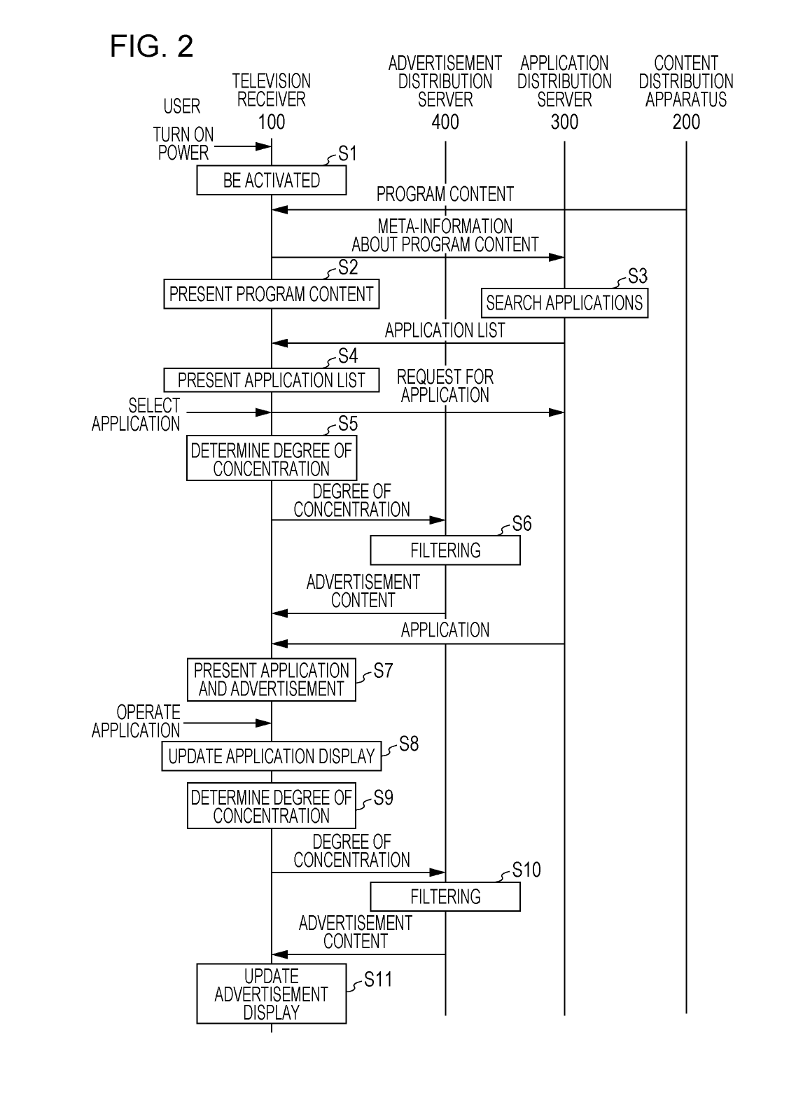

Referring to FIG. 2, exemplary operations in the system constituted by the television receiver 100, the content distribution apparatus 200, the application distribution server 300, and the advertisement distribution server 400 will be described. FIG. 2 is a sequence chart illustrating exemplary operations in the system after the power of the television receiver 100 is turned on.

As illustrated in FIG. 2, when a user turns on the power of the television receiver 100, the television receiver 100 is activated (step S1). In the process of activating the television receiver, a process of activating a television viewing APP is also included.

When activation of the television receiver 100 is completed, the receiving unit 111 receives program content for the latest channel which was selected in the television receiver 100, from the content distribution apparatus 200.

Then, the content processing engine 112 extracts meta-information (such as the channel, the title) from the program content, and transmits the extracted meta-information to the application distribution server 300 via the communication unit 121.

After that, the content processing engine 112 decodes the program video of the program content, and the presentation controller 140 displays the program video on the touch-panel-type display unit 150 (step S2).

The application distribution server 300 which has received the meta-information of the program content searches for APPs related to the program content (step S3), and transmits a list of APPs (APP list) which are hit in the search, to the television receiver 100.

The application processing engine 122 of the television receiver 100 which has received the APP list displays the APP list on the touch-panel-type display unit 150 (step S4).

After step S4, assume that the user selects an APP from the APP list.

The application processing engine 122 requests transmission of the selected APP from the application distribution server 300.

Assume that, soon after that, a certain period has elapsed after activation of the television receiver. Since no APPs which are being activated are present other than the television viewing APP, the degree-of-concentration determination unit 131 determines the degree of concentration to be 0 (default value) (step S5). The advertisement display-position determination unit 133 transmits the value “0” which indicates the degree of concentration, via the communication unit 132 to the advertisement distribution server 400. The advertisement display-position determination unit 133 obtains the meta-information of the program content which is being played back, from the content processing engine 112, and transmits the meta-information to the advertisement distribution server 400. A preference-information accumulation unit (not illustrated) transmits preference information of the user which is generated on the basis of a viewing history or a program search history, to the advertisement distribution server 400.

The advertisement distribution server 400 which has received the value indicating the degree of concentration and the meta-information extracts multiple pieces of advertisement data for the sponsors involved in distribution of the program content which is being played back, from many pieces of advertisement data stored in the advertisement distribution server 400. The advertisement distribution server 400 selects advertisement data which is to be transmitted to the television receiver 100, from the multiple extracted pieces of advertisement data on the basis of the degree of concentration (step S6), and transmits the selected advertisement data to the television receiver 100.

After that, assume that the application distribution server 300 transmits the APP selected by the user, to the television receiver 100.

In step S7, the application processing engine 122 activates the received APP so as to generate an UI screen for the APP, and the presentation controller 140 displays the UI screen on the touch-panel-type display unit 150. In step S7, the advertisement display-position determination unit 133 determines an area in which the advertisement image is to be displayed, on the basis of the value determined by the degree-of-concentration determination unit 131 in step S5, and the presentation controller 140 displays the received advertisement image in the area.

After step S7, when an operation for the APP is performed, the application processing engine 122 performs a process according to the operation, and the presentation controller 140 updates the display for the APP (S8).

It is assumed that a certain period from the time point of the process in S5 has elapsed after the process in S8 is performed once or more. The degree-of-concentration determination unit 131 determines the degree of concentration on the basis of the type of the APP which is being activated and the frequency of operations that are performed for the APP which is being activated and that are performed from the time point of the process of S5 (step S9). The advertisement selecting unit 130 transmits the value indicating the degree of concentration, via the communication unit 132 to the advertisement distribution server 400. The advertisement selecting unit 130 obtains meta-information of the program content which is being played back, from the content processing engine 112, and transmits the meta-information to the advertisement distribution server 400.

The advertisement distribution server 400 which has received the value indicating the degree of concentration and the meta-information extracts multiple pieces of advertisement data for the sponsors involved in distribution of the program content which is being played back, from many pieces of advertisement data stored in the advertisement distribution server 400. The advertisement distribution server 400 selects advertisement data which is to be transmitted to the television receiver 100, from the multiple extracted pieces of advertisement data on the basis of the degree of concentration (step S10), and transmits the selected advertisement data to the television receiver 100.

In step S11, the television receiver 100 updates the advertisement image which is being displayed. Specifically, the advertisement display-position determination unit 133 determines an area in which the advertisement image is to be displayed, on the basis of the value determined by the degree-of-concentration determination unit 131 in step S9. The presentation controller 140 erases the advertisement image which has been displayed, and displays the newly received advertisement image in the area.

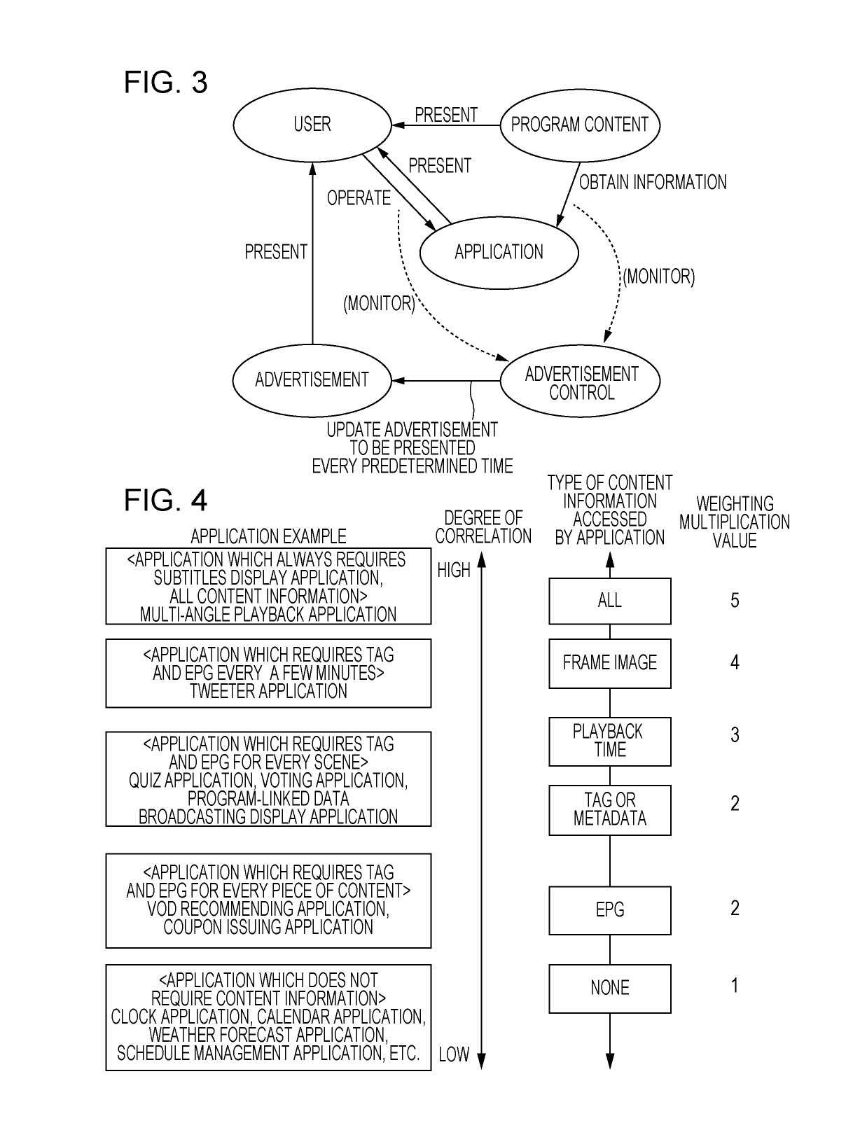

The exemplary operations in the system are described above. The detail of the degree-of-concentration determination process in step S9 will be described below with reference to FIGS. 3 to 6.

[About Detail of Degree-of-Concentration Determination Process]

FIGS. 3 to 5 are diagrams for describing the detail of the degree-of-concentration determination process. FIG. 6 is a flowchart illustrating the detail of the processes in steps in which the degree of concentration is determined and in which advertisement display is updated in FIG. 2.

As illustrated in FIG. 3, the television receiver 100 monitors operations of the user for the APP, and also monitors processes in which the APP obtains content information of the program content which is being played back, thereby updating the advertisement which is being presented, at predetermined time intervals.

Specifically, the television receiver 100 performs the following processes until a certain period elapses from the latest advertisement presentation (advertisement display update), and updates the advertisement display.

That is, the degree-of-concentration determination unit 131 monitors occurrence of the process in which the application processing engine 122 obtains content information from the content processing engine 112, and also monitors occurrence of the process in which the application processing engine 122 receives a user operation event for the APP which is being executed. Every time either of the processes is detected, the degree-of-concentration determination unit 131 records information describing which process was performed as a history. When the former process is detected, the degree-of-concentration determination unit 131 records the type of the content information obtained by the application processing engine 122, in the history.

When a certain period has elapsed, the degree-of-concentration determination unit 131 refers to the history for the period (also referred to as a “target period”), and determines the degree of concentration. Specifically, for each process in which content information is obtained in a target period, a value is obtained by multiplying “1” by a weighting multiplication value (a weighting multiplication value illustrated in FIG. 4) according to the type of the obtained content information. The total of the obtained values is used as the degree of correlation in the target period (step S51 in FIG. 6). For example, when the APP accesses a frame image five times in the target period, the degree of correlation in the target period is “20”.

Therefore, the higher the frequency in which the APP accesses content information is, the higher the degree of correlation is. The degree of correlation obtained when content information accessed by the APP is main information (for example, video data, voice data, subtitles data) is higher than that obtained when content information accessed by the APP is additional information (for example, metadata). For example, as illustrated in FIG. 4, the degree of correlation for a subtitles display APP is higher than that for a voting APP.

In contrast, the value indicating the degree of correlation obtained when the APP never accesses content information is 0 (default value). For example, the value indicating the degree of correlation for a weather forecast APP which is described in FIG. 4 and which never accesses content information is always 0.

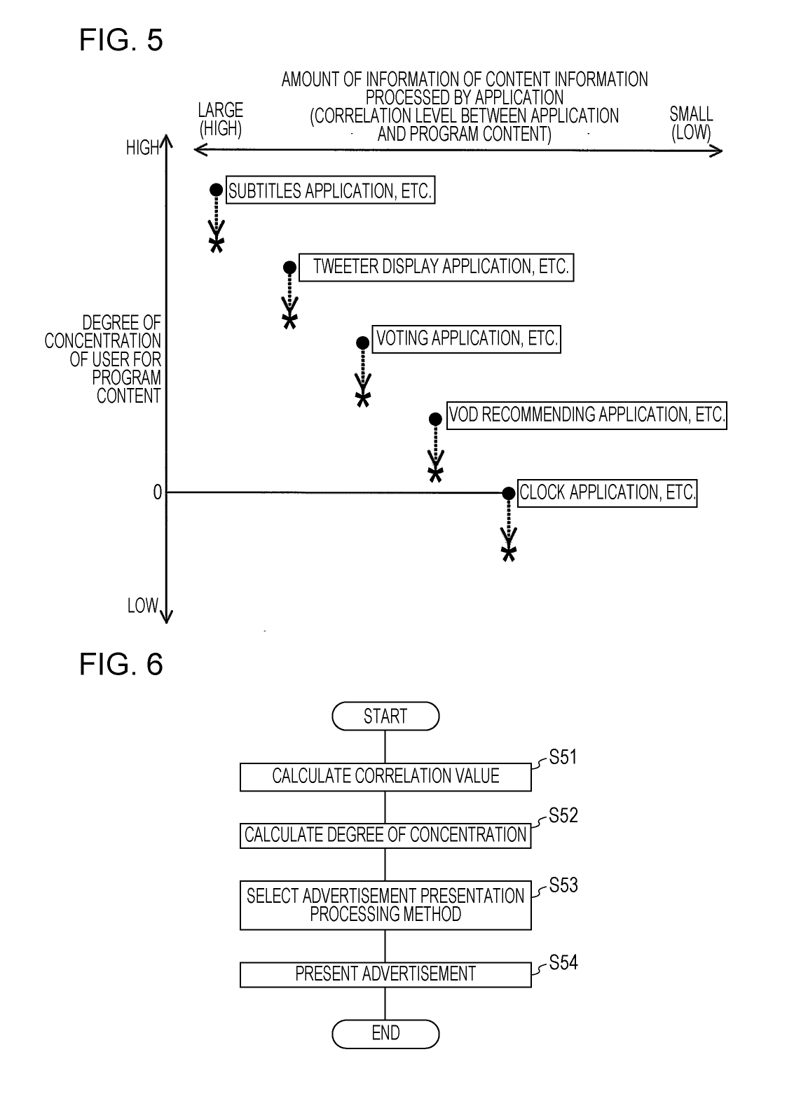

After obtaining the degree of correlation, the degree-of-concentration determination unit 131 obtains the number of user operations for the APP which is being executed, on the basis of the history for the target period. A value obtained by subtracting the number of user operations from the value indicating the degree of correlation (which is represented by in FIG. 5) is used as a value indicating the degree of concentration in the target period (which is represented by * in FIG. 5) (step S52).

That is, it may be said that, as the frequency of user operations for the APP which is being executed is higher, the value indicating the degree of concentration is smaller. For example, when an operation is performed for the weather forecast APP which never accesses content information, the value indicating the degree of concentration is minus. The higher the frequency of the operations is, the smaller the value indicating the degree of concentration is.

When an APP which accesses content information is being executed, the value indicating the degree of concentration is higher than that obtained when an APP which does not access content information is being executed. For example, when an APP which accesses all of the content information constituting the program content (for example, an APP for providing multi-angle display of the program) is executed, the value indicating the degree of concentration is extremely large.

The detail of the degree-of-concentration determination process is described above. The detail of the filtering process in step S6 and step S10 in FIG. 2 will be described.

(About Detail of Filtering Process)

The advertisement distribution server 400 determines whether or not the value indicating the degree of concentration which has been transmitted from the television receiver 100 is equal to or more than a predetermined threshold.

When the advertisement distribution server 400 determines that the value indicating the degree of concentration is less than the predetermined threshold (for example, 10), the advertisement distribution server 400 selects one or more pieces of advertisement data conforming to user preference, on the basis of the preference information received along with the value indicating the degree of concentration and on the basis of the meta-information of the program content.

For example, when the preference information of the user indicates that the user prefers “soccer”, advertisement data including “soccer” as information indicating a genre is selected from multiple pieces of advertisement data for the sponsors involved in distribution of the program content.

For example, when the preference information of the user indicates that the first preference of the user is “soccer”, and that the second preference is “movie”, advertisement data including “soccer” and “movie” as information indicating genres is selected. That is, the advertisement distribution server 400 selects two or more pieces of advertisement data in the descending order of the degree of conformance to the user preference.

When it is determined that the value indicating the degree of concentration is equal to or more than the predetermined threshold, advertisement data having the highest relevance to the program content is selected from the multiple pieces of advertisement data for the sponsors involved in distribution of the program content, on the basis of the meta-information of the program content. Specifically, among the multiple pieces of advertisement data for the sponsors involved in distribution of the program content, advertisement data having the highest degree of association which is indicated by the metadata is selected. Instead of the advertisement data having the highest relevance to the program content, all of the advertisement data having relevance to the program content (that is, all of the advertisement data whose value indicating the degree of association with the metadata is not the minimum value (for example, 0)) may be selected. Alternatively, all of the advertisement data whose value indicating the degree of association with the metadata is equal to or more than a predetermined threshold may be selected.

The advertisement distribution server 400 transmits one or more pieces of the selected advertisement data to the television receiver 100.

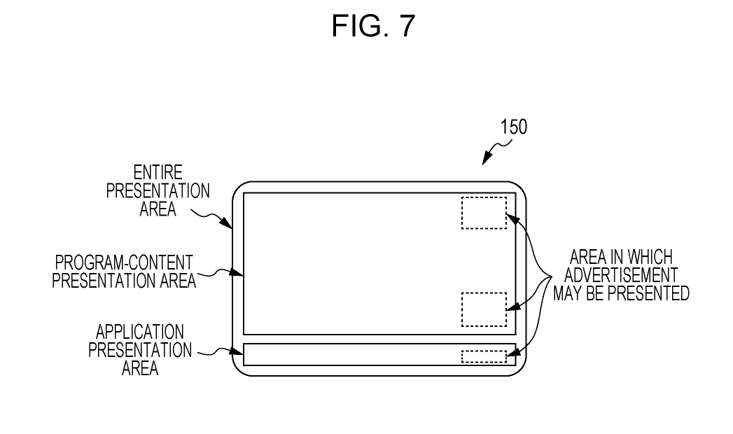

The detail of the filtering process is described above. The detail of the advertisement presentation process in step S7 in FIG. 2 and the detail of the advertisement display update process in step S11 in FIG. 2 will be described with reference to FIGS. 6 and 7.

(About Detail of Advertisement Presentation Process and Advertisement Display Update Process)

FIG. 7 is a diagram which exemplarily illustrates an area in which the program content is presented, an area in which an APP is presented, and areas in which advertisements may be presented, on the touch-panel-type display unit 150.

The advertisement display-position determination unit 133 determines whether the advertisement image in each piece of advertisement data selected in the filtering process is to be displayed in the program-content presentation area or in the application presentation area, on the basis of the value indicating the degree of concentration (step S53 in FIG. 6).

Specifically, when the value indicating the degree of concentration is equal to or more than the predetermined threshold, the advertisement display-position determination unit 133 determines that the advertisement image is to be displayed in an area in which an advertisement may be presented, in the program-content presentation area. When the value indicating the degree of concentration is less than the predetermined threshold, the advertisement display-position determination unit 133 determines that the advertisement image is to be displayed in an area in which an advertisement may be presented, in the application presentation area. The areas in which advertisements may be presented, in the program-content presentation area may be provided, for example, as illustrated in FIG. 7, at the upper right end and the lower right end of the program-content presentation area.

The advertisement display-position determination unit 133 supplies each advertisement image to the presentation controller 140 along with information indicating which area is to be used to display the advertisement image.

When advertisement images have been displayed (for example, in the case of step S11), the presentation controller 140 erases the advertisement images, and displays each advertisement image supplied along with the supplied information, in the area determined on the basis of the information (in step S54 in FIG. 6).

An area in which an advertisement may be presented, in the application presentation area may be an area close to an operation button of the APP. In this case, an effect in which the user who is operating the APP easily notices the advertisement image is achieved.

(Advantages of Television Receiver 100)

As described above, in the television receiver 100, the content processing engine 112 plays back the video of program content, and the degree-of-concentration determination unit 131 determines the frequency of operations for the application whose execution is specified by the user.

The degree-of-concentration determination unit 131 calculates the value which indicates the degree of concentration and which is made smaller as the frequency of operations for the application which is being executed is higher. The degree-of-concentration determination unit 131 uses an algorithm in which a value calculated when operations, the number of which is N (N: integer), for a quiz APP (APP accessing content information) are detected is made larger than a value calculated when operations, the number of which is N, for the weather forecast APP (APP which does not access content information) are detected, thereby calculating the value indicating the degree of concentration. This is because it is presumed that the user is interested in the program content (that is, has a high degree of concentration for the program content) when the user causes the television receiver 100 to execute an application related to the program content which is being played back (for example, an application which accesses data included in the program content).

The presentation controller 140 displays an advertisement selected from multiple advertisements including advertisements having relevance to the program content. When the value indicating the degree of concentration is equal to or more than the predetermined threshold, the presentation controller 140 displays an advertisement having relevance to the program content.

Therefore, when it is determined that the degree of concentration of the user for the program content is high on the basis of the calculated value indicating the degree of concentration, the television receiver 100 displays an advertisement having relevance to the program content. Thus, the television receiver 100 is capable of performing effective advertisement display according to whether or not the user is interested in the program video which is being played back.

### Second Embodiment

In the system according to the first embodiment, only the advertisement distribution server 400 performs the filtering process. In the present embodiment, the television receiver 100 and the advertisement distribution server 400 collaboratively perform the filtering process.

Specifically, the television receiver 100 transmits only the meta-information of program content to the advertisement distribution server 400.

The advertisement distribution server 400 extracts multiple pieces of advertisement data for the sponsors involved in distribution of the program content, from many pieces of advertisement data stored in the advertisement distribution server 400, on the basis of the meta-information. Then, the advertisement distribution server 400 transmits the multiple extracted pieces of advertisement data to the television receiver 100.

The advertisement display-position determination unit 133 of the television receiver 100 uses the same algorithm as the advertisement distribution server 400 to select one or more pieces of advertisement data from the multiple pieces of advertisement data received from the advertisement distribution server 400.

For the processes other than the filtering process, the system according to the present embodiment performs processes similar to those in the system according to the first embodiment. Therefore, the detail of the processes other than the filtering process will not be described.

### Third Embodiment

The television receivers 100 according to the first embodiment and the second embodiment display an advertisement image in the program-content presentation area or the application presentation area. The television receiver 100 according to the present embodiment displays an advertisement image in an area which belongs to neither of the program-content presentation area nor the application presentation area.

Specifically, when the value indicating the degree of concentration is equal to or more than the predetermined threshold, the advertisement display-position determination unit 133 determines that an advertisement image is to be displayed close to the program-content presentation area (an area closer to the program-content presentation area than the application presentation area). When the value indicating the degree of concentration is less than the predetermined threshold, the advertisement display-position determination unit 133 determines that an advertisement image is to be displayed close to the application presentation area (an area closer to the application presentation area than the program-content presentation area).

The presentation controller 140 displays each advertisement image at a position close to the program-content presentation area or close to the application presentation area on the basis of information indicating which area is an area near which each advertisement image supplied from the advertisement display-position determination unit 133 is to be displayed.

For the processes other than the advertisement presentation process (advertisement display update process), the television receiver 100 according to the present embodiment performs processes similar to those of the television receivers 100 according to the first embodiment and the second embodiment. Therefore, the detail of the processes other than the advertisement presentation process (advertisement display update process) will not be described.

### Fourth Embodiment

A television receiver according to another embodiment of the present invention will be described.

The television receiver according to the present embodiment has a configuration similar to that of the television receiver 100 according to the first embodiment. However, the television receiver according to the present embodiment is different from the television receiver 100 according to the first embodiment in that the advertisement display-position determination unit receives a CM movie from an advertisement distribution server different from the advertisement distribution server 400.

For each of many pieces of program content, the advertisement distribution server stores multiple pieces of advertisement content (CM movie data) for the sponsors involved in distribution of the program content. For each of the many pieces of program content, in the advertisement distribution server, information indicating which CM movie data stored in the advertisement distribution server is CM movie data for the sponsors involved in distribution of the program content is recorded.

The CM movie data for the sponsors is constituted by actual data (movie data) and metadata. The metadata includes information indicating the degree of association between the CM movie and the program content whose distribution is one in which the sponsors are involved, and also includes text information indicating the name of a product or a service introduced in the CM movie.

(Exemplary Operations in System)

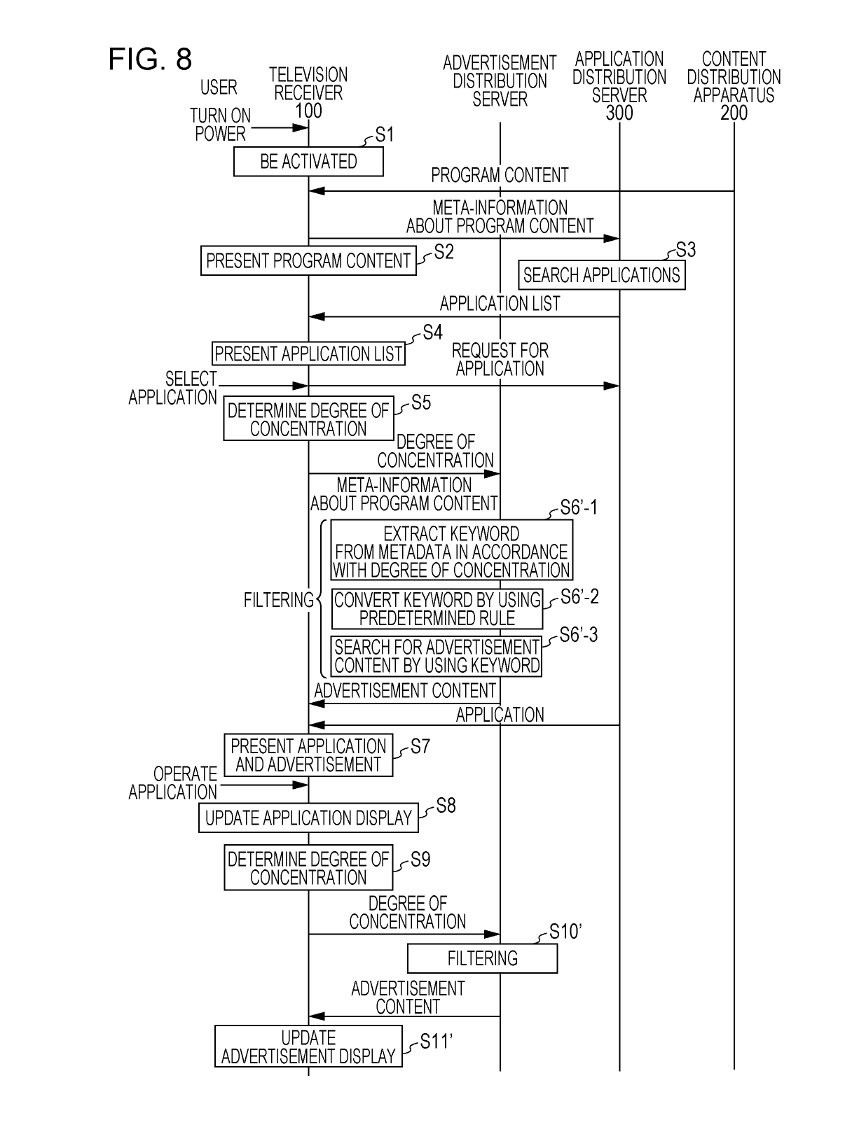

Exemplary operations in a system constituted by the television receiver 100, the content distribution apparatus 200, the application distribution server 300, and the advertisement distribution server according to the present embodiment will be described below with reference to FIGS. 8 to 10.

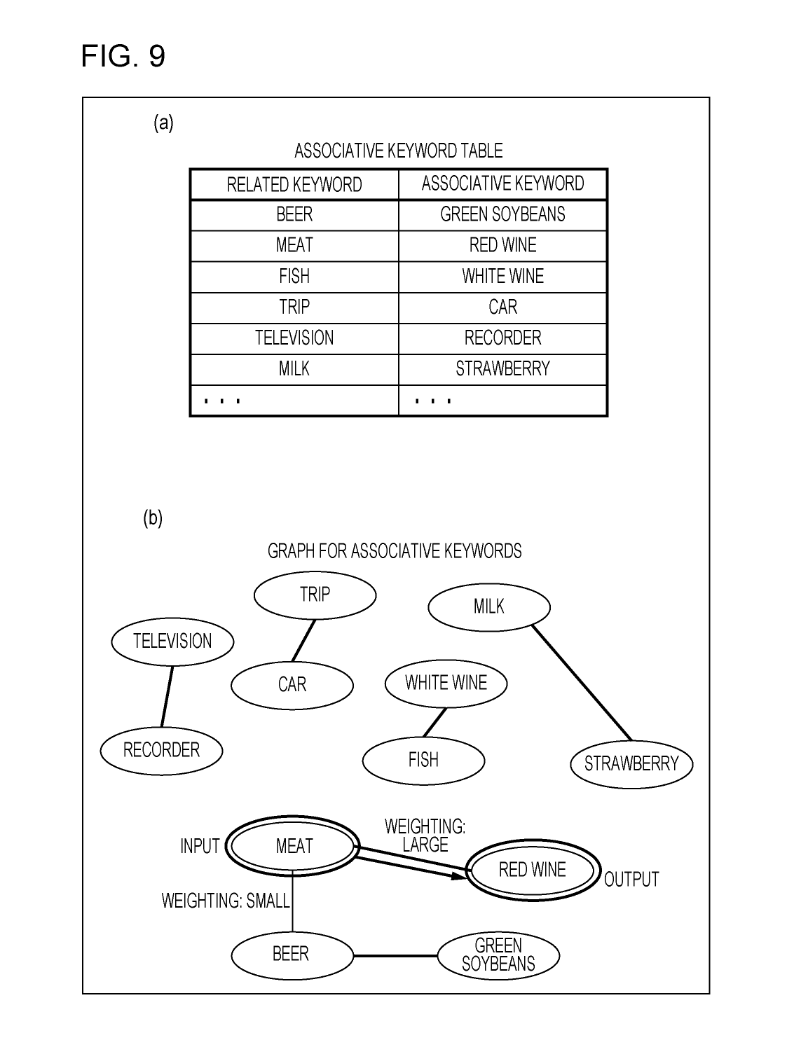

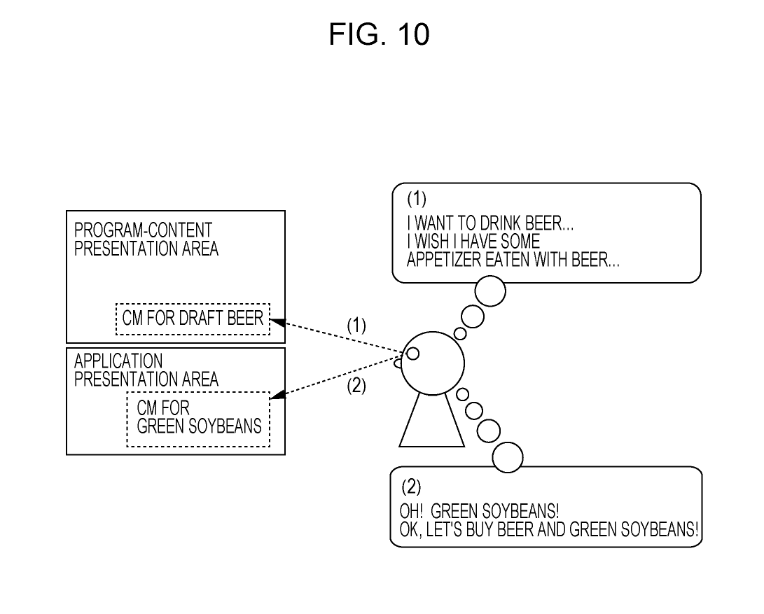

FIG. 8 is a sequence chart illustrating exemplary operations in the system which are performed after the power of the television receiver 100 is turned on. FIG. 9 includes schematic diagrams illustrating data in which a keyword (word) and a keyword (association word of the word) having associative relation with the keyword are associated with each other and which is stored in the advertisement distribution server. FIG. 10 is a schematic diagram which illustrates two CM movies displayed on the television receiver 100, and which also illustrates a viewer of a program who is viewing the two CM movies.

The television receiver 100 according to the present embodiment performs the processes from step S1 to step S5 in a way similar to that of the television receiver 100 according to the first embodiment. Therefore, the processes from step S1 to step S5 will not be described, and processes after step S5 will be described.

After step S5, the advertisement display-position determination unit 133 transmits the value “0” indicating the degree of concentration via the communication unit 132 to the advertisement distribution server. The advertisement display-position determination unit 133 obtains the meta-information of the program content which is being played back, from the content processing engine 112, and transmits the meta-information to the advertisement distribution server.

The advertisement distribution server which has received the value indicating the degree of concentration and the meta-information (such as a channel, a title) extracts all of the CM movie data for the sponsors involved in distribution of the program content which is being played back, from many pieces of CM movie data stored in the advertisement distribution server, on the basis of the meta-information. The advertisement distribution server selects one of two pieces of CM movie data which are to be transmitted to the television receiver 100 (data of a CM movie to be displayed in the program-content presentation area), on the basis of the degree of concentration. The advertisement distribution server may use a method similar to that for the advertisement distribution server 400, to select CM movie data.

The advertisement distribution server extracts the name of a product or a service introduced in the CM movie (that is, a keyword related to the CM movie), from the metadata of the selected CM movie data (step S6′-1).

After step 6′-1, the advertisement distribution server converts the extracted keyword (hereinafter referred to as a “related keyword”) into a keyword having associative relation (hereinafter referred to as an “associative keyword”) (step S6′-2). For example, when the related keyword is “beer”, the advertisement distribution server may refer to tabular data illustrated in FIG. 9(a) to convert the related keyword into an associative keyword “green soybeans”. The data in which a keyword related to a CM movie and an associative keyword having associative relation with the keyword are associated with each other may be generated, for example, by using a known data mining method. Alternatively, the data in FIG. 9(a) may be generated by an administrator of the advertisement distribution server registering a pair of two keywords determined to have associative relation, in the advertisement distribution server at any time. The advertisement distribution server may automatically delete a pair which has not been accessed for a certain period, from the data in FIG. 9(a).

After step S6′-2, the advertisement distribution server selects the other of the two CM movie data which are to be transmitted to the television receiver 100 (data of a CM movie to be displayed in the application presentation area). Specifically, the advertisement distribution server extracts such CM movie data that the name of a product or a service indicated by the text information in the metadata matches the associative keyword, from all of the CM movie data for the sponsors involved in distribution of the program content which is being played back (step S6′-3). For example, in step S6′-3, the advertisement distribution server may extract such CM movie data that the name of the product or the service completely or partially matches the associative keyword.

After step S6′-3, the advertisement distribution server distributes the CM movie data selected just before step S6′-1, as main CM movie data to the television receiver 100. The advertisement distribution server distributes the CM movie data selected in step S6′-3, as sub CM movie data to the television receiver 100.

In step S7, the application processing engine 122 activates the received APP so as to generate a UI screen for the APP. The presentation controller 140 displays the UI screen on the touch-panel-type display unit 150. In the same step, the advertisement display-position determination unit 133 determines that the display position of the main CM movie is to be located in the program-content presentation area, and that the display position of the sub CM movie is to be located in the application presentation area, and plays back each piece of CM movie data. The presentation controller 140 presents the main CM movie in the program-content presentation area, and plays back the sub CM movie data so as to present the sub CM movie in the application presentation area.

In the above-described example, as illustrated in FIG. 10, the television receiver 100 presents a CM movie about beer in the program-content presentation area, and presents a CM movie about green soybeans in the application presentation area.

In step S7, without playback of the main CM movie data, the sub CM movie data may be played back, whereby only the sub CM movie is presented in the program-content presentation area or in the application presentation area. For example, the television receiver 100 may present only the CM movie about green soybeans in the program-content presentation area or in the application presentation area. When only the sub CM movie data is presented, it may be determined whether the CM movie data is to be displayed in the program content area or in the application presentation area, in accordance with the degree of concentration.

The process in step S7 enables television receiver 100 to motivate a viewer of the program to purchase two kinds of food and drink which are eaten and drunk together (for example, beer and green soybeans) or two kinds of products which are used together (for example, a television and a recorder) from the sponsors of the program at the same time. Similarly, the television receiver 100 enables a viewer of the program to be motivated to receive two kinds of services which are often used in the same period (for example, supplying accommodations and supplying a rent-a-car) from the sponsors of the program.

The processes after step S8 are performed as follows. That is, in step S8 and step S9, the television receiver 100 performs the processes in step S8 and step S9 which are described in the first embodiment. The television receiver 100 performs the processes from step S6′-1 to step S6′-3 in step S10′. Further, in step S11′, the television receiver 100 erases the two CM movies which have been displayed, and presents the main CM movie and the sub CM movie which are newly received, in the program-content presentation area and the application presentation area, respectively.

(About Step S6′-2)

In step S6′-2, the advertisement distribution server may refer to the graph-structured data illustrated in FIG. 9(b) to convert a related keyword into an associative keyword.

As seen from FIG. 9(b), this data describes that one keyword is associated with one or more keywords having associative relation with the keyword. For each pair of two keywords having associative relation, this data includes a weighting value indicating the magnitude of the degree of correlation between the two keywords constituting the pair. In other words, the data in FIG. 9(b) is data in which each keyword is used as a node, and which describes a weighted graph in which a weighting value between the keywords corresponding to nodes is added to the edge between the nodes.

As a result of reference to the data in FIG. 9(b), in the case where it is confirmed that the keyword extracted in step 6′-1 (related keyword) is associated with multiple keywords, the advertisement distribution server refers to a weighing value for each pair which includes the related keyword, and converts the related keyword into the keyword (associative keyword) having the highest degree of correlation with the related keyword, among the multiple keywords. For example, in the case where a keyword of “meat” is extracted in step 6′-1 and where data in FIG. 9(b) is referred to in step S6′-2, “meat” is converted into “red wine”. This is because, although “meat” is associated with two keywords (“red wine” and “beer”), the degree of correlation of “red wine” with “meat” is higher than that of “beer”.

As a result of reference to the data in FIG. 9(b), in the case where it is confirmed that the keyword (related keyword) extracted in step 6′-1 is associated with one keyword (associative keyword), the advertisement distribution server converts the related keyword into the associative keyword.

For example, a weighting value in the data in FIG. 9(b) may be set (registered or updated) by the advertisement distribution server analyzing a large amount of text data which is input as training data. Specifically, as the frequency in which text containing both of two keywords having associative relation appears in the training data is higher, a larger weighting value may be set between the two keywords. For example, when the amount of text which contains both of “meat” and “red wine” and which is included in the training data is larger than that of text which contains both of “meat” and “beer” and which is included in the training data, the weighting value indicating the degree of correlation between “meat” and “red wine” may be set larger than that between “meat” and “beer”.

Alternatively, the advertisement distribution server may set (register or update) a weighting value in the data in FIG. 9(b) by using another method. For example, for each pair of two keywords having associative relation, the advertisement distribution server may count, for each predetermined period, the number of playback operations in which the content playback device plays back a CM movie for a product or a service whose name includes one of the keywords, in parallel with a CM movie for a product or a service whose name includes the other keyword. Every time the predetermined period has elapsed, the advertisement distribution server may set the weighting value between the two keywords corresponding to the two CM movies larger, as the number of playback operations in which the content playback device concurrently plays back the two CM movies is larger in the period.

To generate the data in FIG. 9(b), for various types of program content, a keyword may be extracted from the meta-information (such as a title, program information) of program content, and the extracted keyword may be registered as a node. In the case where the advertisement distribution server analyzes the training data and where it is confirmed that text containing both of two keywords registered as nodes appears a predetermined number or more, the advertisement distribution server may associate the two keywords with each other (that is, provide an edge between the corresponding two nodes). Alternatively, for an advertisement to be displayed in the application presentation area, a user may perform an interaction such as selection of the advertisement, and weighting may be set in accordance with the number of interactions. For example, in the case where a CM movie for beer is presented in the program-content presentation area and where a CM movie for green soybeans is presented in the APP display area, when a user touches the CM movie display area for green soybeans, the advertisement server makes the weighting for the edge between beer and green soybeans larger. The metadata of CM movie data may include a URL for a shopping site (for example, a shopping site in which green soybeans produced by a sponsor are sold) on the Internet. In this case, when a user touches the CM movie display area, the television receiver 100 may display the shopping site. When the user purchases a product in the shopping site displayed by using a touch with the CM movie display area as a trigger, the advertisement distribution server may detect the purchase and may set weighting of the edge (in the above-described example, weighting of the edge between green soybeans and beer) larger.

(First Additional Matter)

The degree-of-concentration determination process described in the first embodiment is merely an example. In the first embodiment, a value obtained by subtracting the number of operations for an APP from a value indicating the degree of correlation between the APP and the program content is set as a value indicating the degree of concentration. A correction value may be obtained from the value indicating the degree of correlation, and a value obtained by subtracting the number of operations for the APP from the correction value may be set as a value indicating the degree of concentration.

The correction value may be obtained, for example, by multiplying the value indicating the degree of correlation by a positive correction coefficient. The correction coefficient by which the degree of correlation is multiplied may be constant regardless of the magnitude of the degree of correlation, or may be made different depending on the magnitude of the degree of correlation. It is necessary to set the correction coefficient so that the correction value is made relatively larger as the degree of correlation is relatively higher. As long as the correction coefficient is set in this way, the correction coefficient may be set so that the correction coefficient is maximum when the value indicating the degree of correlation is equal to a reference value and that the correction coefficient is made smaller as the difference between the value indicating the degree of correlation and the reference value is larger. Alternatively, the correction coefficient may be set so that the correction coefficient is minimum when the value indicating the degree of correlation is equal to a reference value and that the correction coefficient is made larger as the difference between the value indicating the degree of correlation and the reference value is larger.

(Second Additional Matter)

The television receiver 100 according to the first embodiment periodically updates advertisement display. However, the present invention is not limited to this.

The television receiver 100 may differently set the timing at which the degree of concentration is determined next, depending on whether or not the value indicating the degree of concentration is equal to or more than the predetermined threshold.

That is, when the television receiver 100 determines that the value indicating the degree of concentration is equal to or more than the predetermined threshold, the television receiver 100 may display the advertisement image having the highest degree of association with the program content, in the program-content presentation area for a relatively long period. After the period has elapsed, the television receiver 100 may determine the degree of concentration again. When the television receiver 100 determines that the value indicating the degree of concentration is less than the predetermined threshold, the television receiver 100 may display one or more advertisement images conforming to the user preference, in the application presentation area for a relatively short period. After the period has elapsed, the television receiver 100 may determine the degree of concentration again. The length of the above-described “relatively long period” and that of the above-described “relatively short period” may be 30 seconds and 5 seconds, respectively. When multiple advertisement images conforming to the user are displayed, the number of advertisement images to be displayed desirably ranges between 3 and 5.

Alternatively, when the television receiver 100 determines that the value indicating the degree of concentration is equal to or more than the predetermined threshold, the television receiver 100 may display the advertisement image having the highest degree of association with the program content in the program-content presentation area until the next scene of the program content is played back. The television receiver 100 may determine the degree of concentration again when playback of the next scene is started.

(Third Additional Matter)

In the first embodiment, the television receiver 100 may be provided with a person detecting sensor.

The degree-of-concentration determination unit 131 may record a history only when the person detecting sensor detects a person around the sensor.

Alternatively, in the case where the process in which the application processing engine 122 obtains content information from the content processing engine 112 is detected, the degree-of-concentration determination unit 131 may record a history only when the person detecting sensor detects a person around the sensor at that time. In contrast, when the process in which the application processing engine 122 receives a user operation event for the APP which is being executed is detected, the degree-of-concentration determination unit 131 may record a history regardless of whether or not a person is detected around the sensor.

The degree-of-concentration determination unit 131 may determine the degree of concentration of the user for the program content on the basis of the history thus recorded. When the television receiver 100 has such a configuration, the degree of concentration of the user for the program content may be correctly grasped.

(Fourth Additional Matter)

In the advertisement distribution server 400, multiple pieces of advertisement data may be prepared for each advertisement. For example, as advertisement data about advertisement for soccer shoes produced by A Corp., advertisement data including a still image as an advertisement image and advertisement data including an animation GIF image as an advertisement image may be prepared.

In this case, when the advertisement distribution server 400 determines that the value indicating the degree of concentration is equal to or more than the predetermined threshold, the advertisement distribution server 400 may transmit the advertisement data including a still image, among the two pieces of advertisement data for the advertisement having the highest relevance to the program content, to the television receiver 100. When the advertisement distribution server 400 determines that the value indicating the degree of concentration is less than the predetermined threshold, the advertisement distribution server 400 may transmit the advertisement data which includes an animation GIF image and which is about advertisement conforming to the user preference, to the television receiver 100.

When the presentation controller 140 of the television receiver 100 is supplied with information indicating that each advertisement image is to be displayed in the program-content presentation area or near the program-content presentation area, the presentation controller 140 may switch the advertisement image to be displayed, by cross-fading advertisement images when advertisement display is updated.

The presentation controller 140 may display each advertisement image with a frame border. When the presentation controller 140 is supplied with information indicating that each advertisement image is to be displayed in the application presentation area or near the application presentation area, the presentation controller 140 may blink the advertisement image or the frame border of the advertisement image, during display of the advertisement image. Alternatively, for each advertisement image, the presentation controller 140 may produce an animation effect with which a user perceives as if the image is swinging, during display of the advertisement image.

When the television receiver 100 displays each advertisement image with a frame border in the program-content presentation area or near the program-content presentation area, the television receiver 100 may adjust the color of the frame border so that the border between the advertisement image and the program video is blurred. Specifically, the advertisement display-position determination unit 133 may specify the average color or the background color of the program video, and the presentation controller 140 may display each advertisement image with a frame border of the specified color.

When each advertisement image is displayed in an area in which an advertisement may be presented and which is in the application presentation area, the television receiver 100 may display the advertisement image at a position farther from the program-content presentation area, as the value indicating the degree of concentration is smaller.

The television receiver 100 having the above-described configuration enables advertisement data to be easily viewed by a user or to be made inconspicuous from the user, whereby an advertiser may select a display option from various display options on the basis of his/her advertisement display policy.

(Fifth Additional Matter)

The advertisement display-position determination unit 133 may transmit the meta-information of the APP (for example, the name of the APP) which is being executed by the television receiver 100, for example, along with the value indicating the degree of concentration to the advertisement distribution server 400.

In this case, when the value indicating the degree of concentration is less than the predetermined threshold, the advertisement distribution server 400 may select advertisement data related to the APP, from advertisement data for the sponsors involved in distribution of the program content which is being played back, on the basis of the meta-information of the APP. For example, when the APP which is being executed by the television receiver 100 is a route search APP, the advertisement distribution server 400 may select advertisement data for an air carrier or a railroad corporation on the basis of the meta-information of the route search APP, if such advertisement data is stored in the advertisement distribution server 400.

The advertisement distribution server 400 may transmit the selected advertisement data to the television receiver 100.

(Sixth Additional Matter)

The history referred to by the degree-of-concentration determination unit 131 in order to determine the degree of concentration may be recorded by the application processing engine 122, not by the degree-of-concentration determination unit 131.

The degree-of-concentration determination unit 131 does not need to record the history in order to determine the degree of concentration. In this case, every time the process in which the application processing engine 122 obtains content information from the content processing engine 112 or the process in which the application processing engine 122 receives a user operation event for the APP which is being executed is detected, the degree-of-concentration determination unit 131 updates a specified variable.

The default value of the specified variable is 0. Every time advertisement display is updated, the specified variable is reset to 0. When the process in which the application processing engine 122 obtains content information from the content processing engine 112 is detected, the degree-of-concentration determination unit 131 increments the value of the above-described variable by a value according to the type of the content information (a value ranging between “1” and “5”). When the process in which the application processing engine 122 receives a user operation event for the APP which is being executed is detected, the degree-of-concentration determination unit 131 decreases the value of the above-described variable by 1.

At a timing at which advertisement display is updated, the degree-of-concentration determination unit 131 determines the value of the above-described variable at that time point to be the value indicating the degree of concentration. Upon completion of the determination of the degree of concentration, the degree-of-concentration determination unit 131 resets the value of the above-described variable to 0.

(Seventh Additional Matter)

Among APPs, there is one displaying a screen for promoting a user operation. When such an APP (for example, the above-described quiz APP) is being executed, the degree-of-concentration determination unit 131 may specify a time (reaction time) from a time point at which the APP displays the above-described screen to a time point at which a user performs an operation. To do this, the application processing engine 122 measures the reaction time, and supplies the measured reaction time to the degree-of-concentration determination unit 131.

When the process in which the application processing engine 122 obtains content information from the content processing engine 112 is performed, the value added to the variable by the degree-of-concentration determination unit 131 may be made different depending on the length of the latest supplied reaction time. Specifically, as the reaction time is shorter, the degree-of-concentration determination unit 131 may make the value added to the variable larger. This is because, in the example of the above-described quiz APP, a short reaction time indicates that the degree of concentration for quizzes given in the program (that is, the degree of concentration for the program content) is high.

Even when a user operation is performed, if the application processing engine 122 does not obtain content information from the content processing engine 112, the value subtracted from the variable by the degree-of-concentration determination unit 131 may be made different depending on the length of the latest supplied reaction time. Specifically, the degree-of-concentration determination unit 131 may set the value subtracted from the variable larger as the reaction time is shorter. This is because a short reaction time indicates a high degree of concentration for the APP irrelevant to the program (that is, a low degree of concentration for the program content).

(Eighth Additional Matter)

As seen from the above description, the television receiver 100 displays an advertisement image in a different manner in accordance with whether or not the value indicating the degree of concentration is equal to or more than the predetermined threshold.

Regarding this, the television receiver 100 may download information indicating which manner is to be used to display an advertisement image when the value indicating the degree of concentration is equal to or more than the predetermined threshold, and indicating which manner is to be used to display an advertisement image when the value indicating the degree of concentration is less than the predetermined threshold.

For example, the television receiver 100 may download the information along with the program content distributed from the content distribution apparatus 200. Alternatively, the television receiver 100 may download the information along with an APP from the application distribution server 300. Instead, the television receiver 100 may download data describing an URL from which the information is acquired, along with the program content or an APP, and may download the information by referring to the URL. Instead, the information may be stored in the television receiver 100 in advance.

The television receiver 100 may determine which manner is to be used to display an advertisement image on the basis of the information.

For example, assume that the information describes that an advertisement image is to be displayed at a position farther from the program content when the degree of concentration is high, and that an advertisement image is to be displayed at a position closer to the program content when the degree of concentration is low. In this example, on the basis of the information, when the value indicating the degree of concentration is equal to or more than the predetermined threshold, the television receiver 100 displays an advertisement image at a position farther from the program content so that the user does not feel that the advertisement image is an obstacle.

(Ninth Additional Matter)

Every time a certain period has elapsed, the television receiver 100 according to the first embodiment refers to the history in the period, and determines the degree of concentration in the period. However, the present invention is not limited to this. That is, every time a certain period (for example, a period of 30 seconds) has elapsed, the television receiver 100 may refer to the history in a certain period (for example, latest three minutes) which is most recently obtained and which includes the certain period, and may determine the degree of concentration in the period.

(Tenth Additional Matter)

In the above-described embodiments, the television receiver 100 is provided with the touch-panel-type display unit 150 which receives a user operation. However, the present invention is not limited to this. That is, a display unit provided for the television receiver 100 does not need to be a touch panel, and an input device, such as a remote controller or a mouse, may be used to receive a user operation.

The television receiver 100 may be a portable television or a stationary large-screen television.

The television receiver 100 may be provided with two display units. One of the display units (for example, the main display) may be used to display the video of the program content, and the other display unit (for example, the sub-display) may be used to display a UI screen of an APP. That is, the television receiver 100 may use the former display unit as the program-content presentation area, and may use the latter display unit as the application presentation area.

(Eleventh Additional Matter)

The television receivers 100 according to the above-described embodiments obtain the value indicating the degree of correlation, and subtract the number of user operations from the value indicating the degree of correlation, thereby obtaining the value indicating the degree of concentration. However, the present invention is not limited to this. That is, to obtain the value indicating the degree of concentration, the television receiver does not need to obtain the value indicating the degree of correlation. The television receiver may obtain the value indicating the degree of concentration on the basis of only the number of user operations for the APP which is being executed. Specifically, a value which is made smaller as the number of user operations is larger may be obtained as the value indicating the degree of concentration. For example, for every certain period, a value obtained by multiplying the number of user operations performed in the period by “−1” may be determined as the value indicating the degree of concentration in the period.

The television receiver having such a configuration displays an advertisement related to the program content when the frequency of operations for the APP which is being executed is low (that is, the degree of concentration for the program content which is being played back is high), and displays an advertisement conforming to the user preference information when the frequency of operations for the APP which is being executed is high.

Therefore, the television receiver having such a configuration may also perform effective advertisement display according to whether or not the user is interested in the video which is being played back.

[Exemplary Implementation Using Software]

The blocks of the television receiver 100, especially, the content processing engine 112, the application processing engine 122, the degree-of-concentration determination unit 131, the advertisement display-position determination unit 133, and the presentation controller 140, may be implemented as hardware by using logic circuits formed on an integrated circuit (IC chip), or may be implemented as software by using a CPU (Central Processing Unit).

In the latter case, the television receiver 100 is provided with a CPU executing commands of programs for implementing the functions, a ROM (Read Only Memory) storing the programs, a RAM (RandomAccess Memory) on which the programs are deployed, a storage device (storage medium) such as a memory storing the programs and various data, and the like. An object of the present invention may be also achieved in such a manner that the television receiver 100 is supplied with a recording medium in which program codes (executable programs, intermediate code programs, source programs) of control programs of the television receiver 100 which is software for achieving the above-described functions are recorded in a computer-readable manner, and that the computer (or the CPU or an MPU) reads and executes the program codes recorded in the recording medium.

As the recording medium, a non-transitory tangible medium, for example, a tape, such as a magnetic tape or a cassette tape, a disk including a magnetic disk, such as a Floppy® Disk/a Hard Disk, and Including an Optical Disk, such as a CD-ROM/an MO/an MD/a DVD/a CD-R, a card, such as an IC card (including a memory card)/an optical card, a semiconductor memory, such as a mask ROM/an EPROM/an EEPROM®/a flash ROM, or a logic circuit, such as a PLD (Programmable logic device) or a FPGA (FieldProgrammable Gate Array), may be used.

The television receiver 100 may be connected to a communication network, and may supply the program codes via the communication network. As long as the communication network is capable of transmitting program codes, the communication network is not limiting. For example, the Internet, an intranet, an extranet, a LAN, an ISDN, a VAN, a CATV communication network, a virtual private network, a telephone network, a mobile communication network, or a satellite communication network may be used. A transmission medium included in the communication network is not limited to one having a specific configuration or a specific type as long as the transmission medium is capable of transmitting program codes. For example, a wired medium, such as IEEE1394, USB, a power-line carrier, a cable TV line, a telephone line, or an ADSL (Asymmetric DigitalSubscriber Line) line, or a wireless medium, such as infrared radiation using IrDA or a remote controller, Bluetooth®, IEEE802.11 radio, HDR (High Data Rate), NFC (Near Field Communication), DLNA® (Digital Living Network Alliance), a cellular phone network, a satellite network, or a digital terrestrial network, may be used. The present invention may be also achieved by using a computer data signal in which the program codes are implemented through electronic transmission and which is embedded in a carrier wave.

The present invention is not limited to the above-described embodiments. Various changes may be made in the scope specified in the claims. An embodiment obtained by appropriately combining technical means disclosed in the different embodiments is also included in the technical scope of the present invention. Further, by combining technical means disclosed in each embodiment, a new technical characteristic may be formed.

### CONCLUSION

A content playback device according to a first aspect of the present invention includes playback means (the content processing engine 112) for playing back a video of program content, detection means (the degree-of-concentration determination unit 131) for detecting operations for an application which is being executed, so as to determine the frequency of operations, and advertisement display means (the advertisement display-position determination unit 133, the presentation controller 140) for displaying one or more advertisements among a plurality of advertisements including a related advertisement which is an advertisement for which relevance to the program content is specified. The advertisement display means displays the related advertisement in the case where the frequency of operations is equal to or less than a predetermined threshold.

Typically, when a user frequently performs an operation for the application while the program content is being played back, it is likely that the user is not interested in the program content (has a low degree of concentration for the program content).

The above-described configuration causes the content playback device to display an advertisement having relevance to the program content when the frequency of operations is equal to or less than the predetermined threshold (that is, the degree of concentration of the user for the program content is high). Thus, the content playback device may perform effective advertisement display according to whether or not the user is interested in the program video which is being played back.

The content playback device according to a second aspect of the present invention is such that, in the content playback device according to the first aspect, in the case where the frequency of operations is equal to or less than the predetermined threshold, the advertisement display means desirably displays the related advertisement on the video, or desirably displays the related advertisement at a position closer to a display area of the video than a display area of the application which is being executed.

The above-described configuration exerts a further effect that the content playback device displays an advertisement having relevance to the program content at a position at which the user easily notices the advertisement, when the degree of concentration of the user for the program content is high.

In the content playback device according to the first or second aspect, the content playback device according to a third aspect of the present invention further includes calculation means for calculating a specific value which is made smaller as the frequency of operations detected by the detection means is higher. It is desirable that the specific value calculated by the calculation means in the case where the detection means detects operations, the number of which is N (N: integer), for an application which accesses data (content information, such as frame image data and metadata) included in the program content be larger than the specific value calculated by the calculation means in the case where the detection means detects operations, the number of which is N, for an application (such as a clock APP) which does not access the data.

Typically, when the user causes the content playback device to execute an application related to the program content which is being played back (for example, an application accessing data included in the program content), it is presumed that the user is interested in the program content (that is, the degree of concentration for the program content is high). For example, when the user causes the content playback device to execute an APP which records the program content which is being played back, it is likely that the user is executing the APP because the user is interested in the program content.

The above-described configuration causes the content playback device to calculate the specific value which is made smaller as the frequency of operations for the application which is being executed is higher. When operations which are performed for an application accessing data included in the program content and whose number is equal to N are detected, the calculated value is larger than that obtained when operations which are performed for an application which does not access the data and whose number is equal to N are detected.

Therefore, when the calculated specific value is equal to or more than a predetermined threshold (that is, the degree of concentration of the user for the program content is high), the content playback device displays an advertisement having relevance to the program content. Thus, the content playback device may perform effective advertisement display according to whether or not the user is interested in the program video which is being played back.

The content playback device according to a fourth aspect of the present invention is such that, in the content playback device according to the third aspect, every time a certain period has elapsed, the calculation means calculates the specific value on the basis of the frequency of operations in a certain period which is most recently obtained and which includes the period. It is desirable that, every time the calculation means calculates the specific value, the advertisement display means select an advertisement to be displayed after the period, on the basis of whether or not the specific value is equal to or more than a predetermined threshold. The terms “the period” and “a certain period” in the expression “a certain period which is most recently obtained and which includes the period” may be the same period, or “a certain period” may be longer than “the period”.

The above-described configuration exerts a further effect that the content playback device is capable of performing effective advertisement display according to the change in the degree of concentration when the degree of concentration of the user for the program content changes as playback of the program content proceeds.

In the content playback device according to the third or fourth aspect, the content playback device according to a fifth aspect of the present invention further includes transmission means (advertisement display-position determination unit 133) for transmitting the specific value and metadata of the application which is being executed, to an advertisement distribution apparatus. It is desirable that, in the case where the specific value is less than predetermined threshold, the advertisement distribution apparatus select an advertisement related to the application which is being executed, among the plurality of advertisements on the basis of the metadata, and distribute the selected advertisement to the content playback device. It is desirable that the advertisement display means display the advertisement distributed by the advertisement distribution apparatus.

When the user is interested in the application which is being executed, not in the program content, this may cause the specific value to be less than the predetermined threshold. The user who is interested in the application which is being executed typically operates the application frequently.

The above-described configuration exerts a further effect that the content playback device may cause such a user who has a low degree of concentration for the program content and who has a high degree of concentration for the application which is being executed, to view an advertisement conforming to the user.

In the content playback device according to the third or fourth aspect, the content playback device according to a sixth aspect of the present invention further includes accumulation means for accumulating preference information indicating preference of a user. It is desirable that, in the case where the specific value is less than the predetermined threshold, the advertisement display means select two or more advertisements from the plurality of advertisements in descending order of the degree of conformance to the preference, and display the two or more selected advertisements for a certain period. It is desirable that, in the case where the specific value is equal to or more than the predetermined threshold, the advertisement display means display the related advertisement for a period longer than the certain period.

The above-described configuration causes the content playback device to display an advertisement conforming to the user preference indicated by the accumulated preference information when the calculated specific value is less than the predetermined threshold (that is, it is hardly said that the degree of concentration of the user for the program content is high).

Therefore, the content playback device exerts a further effect that more effective advertisement display may be performed in accordance with whether or not the user is interested in the program video which is being played back.

Since the preference indicated by the accumulated preference information is past preference of the user, it is hardly said that current user preference is not completely reflected. For example, a case may be present in which the user liked soccer, and frequently viewed soccer programs, but in which the user is not interested in soccer now. In this case, it is hardly said that display of an advertisement about soccer shoes which is performed on the basis of the preference information indicating that the user is interested in soccer is effective advertisement display. Therefore, when the degree of concentration of the user for the program content is high, it is desirable that an advertisement having relevance to the program content be displayed rather than an advertisement conforming to the user preference indicated by the accumulated preference information.

As described above, regardless of whether the degree of concentration of the user for the program content is low or high, the content playback device according to the second aspect of the present invention may perform advertisement display which is more effective than that performed by the content playback device which displays an advertisement conforming to the user preference indicated by the accumulated preference information.

The above-described configuration exerts a further effect that the content playback device may cause a user to view an advertisement having relevance to the program content for a long period.

The content playback device according to a seventh aspect of the present invention is such that, in the content playback device according to any one of the third to sixth aspects, in the case where the specific value is less than the predetermined value, the advertisement display means desirably displays the selected advertisement in the display area for the application which is being executed, or desirably displays the selected advertisement at a position closer to the display area for the application which is being executed, than the display area for the video.

The above-described configuration exerts a further effect that, when the degree of concentration of the user for the program content is low (that is, the degree of concentration of the user for the APP is high), the content playback device may display an advertisement conforming to the user at a position at which the user easily notices the advertisement.

An advertisement display method for a content playback device, according to an eighth aspect of the present invention, includes the steps of playing back a video of program content, detecting operations for an application which is being executed, so as to determine the frequency of operations, and displaying one or more advertisements among a plurality of advertisements including a related advertisement which is an advertisement for which relevance to the program content is specified. In the displaying step, the related advertisement is displayed in the case where the frequency of operations is equal to or less than a predetermined threshold.

The above-described configuration causes the advertisement display method according to the eighth aspect of the present invention to exert an effect similar to that of the content playback device according to the first aspect of the present invention.

The content playback devices (content playback devices according to the first to seventh aspects) may be implemented by using a computer. In this case, by operating the computer as the units of the content playback devices, programs for implementing the content playback devices in the computer, and a computer-readable recording medium in which the programs are recorded fall under the scope of the present invention.

### INDUSTRIAL APPLICABILITY

The present invention is suitably applicable to various terminals with which program content may be played back.

### REFERENCE SIGNS LIST

100 television receiver (content playback device)
110 program content processor
112 content processing engine (playback means)
120 application processor
122 application processing engine
130 advertisement processor
131 degree-of-concentration determination unit (detection means, calculation means)
133 advertisement display-position determination unit (advertisement display means, transmission means)
140 presentation controller (advertisement display means)
150 touch-panel-type display unit
200 content distribution apparatus
300 application distribution server
400 advertisement distribution server

1. A content playback device comprising:
circuitry that a video of program content;
detects operations for an application which is being executed, so as to determine a frequency of operations; and
displays one or more advertisements among a plurality of advertisements including a related advertisement which is an advertisement for which relevance to the program content is specified,
wherein the circuitry displays the related advertisement in the case where the frequency of operations is equal to or less than a predetermined threshold.

2. The content playback device according to claim 1,
wherein, in the case where the frequency of operations is equal to or less than the predetermined threshold, the circuitry displays the related advertisement on the video, or displays the related advertisement at a position closer to a display area of the video than a display area of the application which is being executed.

3. The content playback device according to claim 1, wherein the circuitry
calculates a specific value which is made smaller as the frequency of operations is higher,
the specific value calculated in the case where operations, the number of which is N (N: integer), are detected for an application which accesses data included in the program content being larger than the specific value calculated in the case where operations, the number of which is N, are detected for an application which does not access the data.

4. The content playback device according to claim 3,
wherein, the circuitry calculates the specific value, every time a certain period has elapsed on the basis of the frequency of operations in a certain period which is most recently obtained and which includes the period, and
selects an advertisement to be displayed after the period, every time the specific value calculated, on the basis of whether or not the specific value is equal to or more than a predetermined threshold.

5. An advertisement display method for a content playback device, the method comprising
playing back a video of program content;
detecting operations for an application which is being executed, so as to determine the frequency of operations; and
displaying one or more advertisements among a plurality of advertisements including a related advertisement which is an advertisement for which relevance to the program content is specified,
the related advertisement being displayed in the case where the frequency of operations is equal to or less than a predetermined threshold.

6. (canceled)
